(19) United States
(12) Patent Application Publication
(10) Pub. No.: US 2008/0079201 A1
(43) Pub. Date: Apr. 3, 2008

(54) Apparatus for forming large-radii curved surfaces and small-radii creases in sheet material

(75) Inventor: Max W. DURNEY, San Francisco, CA (US)

Correspondence Address: MORGAN, LEWIS & BOCKIUS, LLP, ONE MARKET SPEAR STREET TOWER, SAN FRANCISCO, CA, 94105, US

(73) Assignee: Industrial Origami, Inc., San Francisco, CA (US)

(21) Appl. No.: 11/849,481

(22) Filed: Sep. 4, 2007

Related U.S. Application Data
(60) Provisional application No. 60/824,463, filed on Sep. 4, 2006.

(51) Int. Cl. B29C 51/10

(52) U.S. Cl. 264/570; 425/111

(57) ABSTRACT

A apparatus for forming a three-dimensional (3D) object from a sheet material preferably includes a sheet material, a shaping die defining a cavity adapted to receive at least a portion of the sheet material, a portion of the cavity having a shape corresponding to a desired surface of the 3D object, and a forming member positioned relative to the sheet material opposite the cavity and having a rigid edge having a shape corresponding to a desired small-radii event of the 3D object. When force is applied to the sheet material and to the forming member, the sheet material is forced against the portion of the cavity to form the desired surface, and the rigid edge is forced against the sheet material to form the desired small-radii event. A method of using the apparatus for spline bending of sheet material is also disclosed.

### CROSS-REFERENCES TO RELATED APPLICATIONS

This application claims priority to U.S. Provisional Patent Application No. 60/824,463 filed Sep. 4, 2006 and entitled APPARATUS FOR FORMING LARGE-RADII CURVED SURFACES AND SMALL-RADII CREASES IN SHEET MATERIAL, the entire contents of which is incorporated herein by this reference.

### BACKGROUND OF THE INVENTION

1. Field of the Invention

This invention relates, in general, to an apparatus for forming sheet materials into three-dimensional objects, and more particularly to forming large-radii curved surfaces together with small-radii creases in sheet materials.

2. Description of Related Art

Stamping, drawing and other conventional metal forming techniques have long been used to form three-dimensional (3D) objects from flat sheet materials. One disadvantage of such techniques is that corresponding dies and punches are necessary, which dies and punches require close tolerances and are highly subject to wear and tear.

More recently, hydroforming and other fluid forming techniques have been implemented to form 3D objects from sheet materials. In hydroforming, the die or the punch is replaced by fluid pressure. Generally, one side of the sheet material is exposed to fluid pressure (or a membrane or diaphragm subjected to fluid pressure) and the sheet material is forced against a die or punch to form the desired shape.

Hydroforming is suitable for creating many 3D objects, particularly those having rounded corners. However, hydroforming appears ill suited for creating creases and other small-radii events in sheet material. For example, the fluid pressures may be insufficient to force the sheet material tightly into sharp corners. Instead, the resulting object may be formed with a rounded corner that approximates but does not conform with a sharp corner of the corresponding die or punch.

What is needed is a fluid-forming apparatus which overcomes the above and other disadvantages of known hydroforming equipment.

### BRIEF SUMMARY OF THE INVENTION

In summary, one aspect of the present invention is directed to an apparatus for forming a three-dimensional (3D) object from a sheet material. The apparatus preferably includes a sheet material, a shaping die defining a cavity adapted to receive at least a portion of the sheet material, a portion of the cavity having a shape corresponding to a desired surface of the 3D object, and a forming member positioned relative to the sheet material opposite the cavity and having a rigid edge having a shape corresponding to a desired small-radii event of the 3D object. When force is applied to the sheet material and to the forming member, the sheet material is forced against the portion of the cavity to form the desired surface, and the rigid edge is forced against the sheet material to form the desired small-radii event.

In one embodiment, the cavity further includes a concave corner. The forming member may be a rigid wire. The forming member may be a platen having a substantially flat body and rigid edges. The forming member may have a shape corresponding to the desired object shape. The forming member may have a line of weakness configured to correspond to a bend line in the desired object.

The apparatus may be a hydroforming apparatus applying fluid liquid pressure to the sheet of material. The apparatus may further include a fastener for fastening the forming member to the sheet. The fastener may seal the forming member to the sheet. The seal may be configured to be released after an initial application of fluid pressure such that the sheet may be allowed to be worked further independent of the forming member.

The apparatus may further include a second forming member, wherein a second forming edge and forming edge correspond. The first and second forming members may be fastened by a hinge. The second forming member may be a rigid platen. At least one of the first forming member and second forming member may be fastened to the blank and each of the first and second forming members have shapes corresponding to two adjacent surfaces of the object to be formed. The apparatus may further include shoe defining a liquid reservoir opposite the shaping die for opposing fluid pressure applied to the blank, wherein an outer edge of the first forming member may be secured to an outer side of the shoe. The first and second forming members have shapes corresponding to adjacent surfaces of the object to be formed.

Another aspect of the present invention is directed to method of forming a three-dimensional object from a blank of sheet material including the steps of: providing a shaping die defining a cavity and having a shape corresponding to a desired surface of the three-dimensional object including a small-radii event; providing a blank of sheet material opposite the shaping die; providing a forming member positioned relative to the blank and opposite the cavity, the forming member including a rigid edge corresponding to the small-radii event; clamping the blank between the shaping die and a shoe configured to provide force to the blank; shaping the blank by applying force to the blank and the forming member whereby the blank may be forced against a portion of the cavity and the rigid edge may be forced against the blank to form the desired small-radii event; removing the formed blank; and finishing the formed blank into the desired three-dimensional object.

The forming step may be accomplished by high-pressure gas. The forming step may be accomplished by applying liquid pressure to the sheet of material. The method may further include the step of fastening the forming member to the blank before clamping the blank. The fastening step seals the forming member to the sheet. The method may further include a second forming step wherein the seal may be configured to be released after the first forming step to allow further working of the blank.

Still another aspect of the present invention is directed to an apparatus for forming a three-dimensional object from a sheet of material. The apparatus preferably includes a sheet of material, a shaping die defining a cavity adapted to receive a portion of the sheet and having a shape corresponding to a desired surface of the three-dimensional object, a shoe mounted opposite the shaping die and including a fluid inlet passage for applying pressurized fluid above the sheet, wherein the shoe and the shaping die may be configured to clamp the lateral edges of the blank therebetween, and a platen positioned adjacent to the sheet opposite the cavity and having a body and rigid edge corresponding to a desired small-radii event of the three-dimensional object. Fluid pressure is applied to sheet material and platen such that the sheet may be forced against a portion of the cavity and platen.

The platen may be rotationally fixed at one end to the shoe. The apparatus may be a hydroforming apparatus applying fluid liquid pressure to the sheet of material. The apparatus may further include a fastener for fastening the forming member to the sheet of material. The fastener preferably seals the platen to the sheet. The seal may be configured to be released after an initial application of fluid pressure such that the sheet may be allowed to be worked further independent of the forming member. The apparatus may further include a second platen in hinged engagement with the first platen along a common edge. The platen may have a first portion and a second portion partitioned by a line of weakness. The platen body may be substantially rigid. The platen body may be configured to flex and/or stretch under high pressure into a shape corresponding to a desired surface of the three-dimensional object. The apparatus may further include high-powered gas assist configured for applying instantaneous high pressure to the sheet and platen.

The apparatus for forming sheet materials into three-dimensional objects of the present invention has other features and advantages which will be apparent from or are set forth in more detail in the accompanying drawings, which are incorporated in and form a part of this specification, and the following Detailed Description of the Invention, which together serve to explain the principles of the present invention.

### BRIEF DESCRIPTION OF THE DRAWINGS

FIG. 1 is an exploded, isometric, cross-sectional view of an apparatus in accordance with the present invention.

FIG. 2 is a cross-sectional view of the apparatus of FIG. 1 taken substantially along line 2-2 of FIG. 1.

FIG. 3 is an isometric view of the apparatus of FIG. 1 shown with a shoe and shaping die in a closed position clamping a sheet of material with a forming member therebetween.

FIGS. 4(a), 4(b), 4(c), 4(d) and 4(e) are a sequence of cross-sectional views of the apparatus of FIG. 1 illustrating the forming process in accordance with the present invention.

FIG. 5 is an isometric view of the apparatus of FIG. 1, similar to FIG. 3 but shown with a shaped sheet of material and forming member.

FIG. 6 is an isometric view of the shaped sheet of material of FIG. 5.

FIG. 7 is an isometric view of a finished and trimmed three-dimensional object formed from the sheet of material of FIG. 5.

FIG. 8 is schematic view of another apparatus in accordance with the present invention during an intermediate stage of operation, the apparatus being similar to that shown in FIG. 1 but having a different geometry.

FIG. 9 is a schematic view of the apparatus of FIG. 8 during a final stage illustrating a sheet of material forced into the cavity and unsealed from the forming member.

FIG. 10 is a schematic view of an apparatus similar to that shown in FIG. 8 illustrating a cavity with a flat wall surface opposite the forming member, the apparatus shown in an open position and initial stage of operation.

FIG. 11 is a schematic view of the apparatus of FIG. 10, the apparatus shown in a closed position and intermediate stage.

FIG. 12 is a schematic view of the apparatus of FIG. 10, the apparatus shown in a final stage with the sheet of material forced into the cavity.

FIG. 13 is a schematic view of an apparatus similar to FIG. 8 illustrating the forming member pivotally fixed at one end, the apparatus shown in an open position and initial stage of operation.

FIG. 14 is a schematic view of the apparatus of FIG. 13, the apparatus shown in a closed position and intermediate stage.

FIG. 15(a) is a schematic view of the apparatus of FIG. 13, the apparatus shown in a final stage with the sheet of material forced into the cavity.

FIG. 15(b) is a cross-sectional view of the shaped sheet of material in FIG. 15(a).

FIG. 16(a) is a schematic view of an apparatus similar to that shown in FIG. 13 but having a convex surface, the apparatus shown in a final stage with the sheet of material forced into the cavity, similar to that shown in FIG. 15(a).

FIG. 16(b) is a cross-sectional view a sheet of material in FIG. 16(a).

FIGS. 17(a), 17(b) and 17(c) are a sequence of cross-sectional views similar to FIGS. 4(a)-(e) illustrating the forming process of another apparatus similar to that shown in FIG. 1.

FIGS. 18(a), 18(b) and 18(c) are a sequence of cross-sectional views similar to FIGS. 4(a)-(e) illustrating the forming process of another apparatus similar to that shown in FIG. 1.

FIG. 19 is a schematic illustration of forming members and the sheet material of FIG. 18.

FIG. 20 is a schematic illustration of the forming members and the sheet material of FIG. 18 placed upon a membrane in accordance with the present invention.

FIG. 21 is a schematic illustration of the sheet material during (a) initial, (b) intermediate and (c) final stages of forming corresponding to FIGS. 18(a), 18(b) and 18(c), respectively.

FIGS. 22(a), 22(b) and 22(c) are a schematic illustrations of a 3D product formed from the sheet material during (a) initial, (b) intermediate and (c) final stages of forming corresponding to FIGS. 18(a), 18(b) and 18(c), respectively.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to those embodiments. On the contrary, the invention is intended to cover alternatives, modifications and equivalents, which may be included within the spirit and scope of the invention as defined by the appended claims.

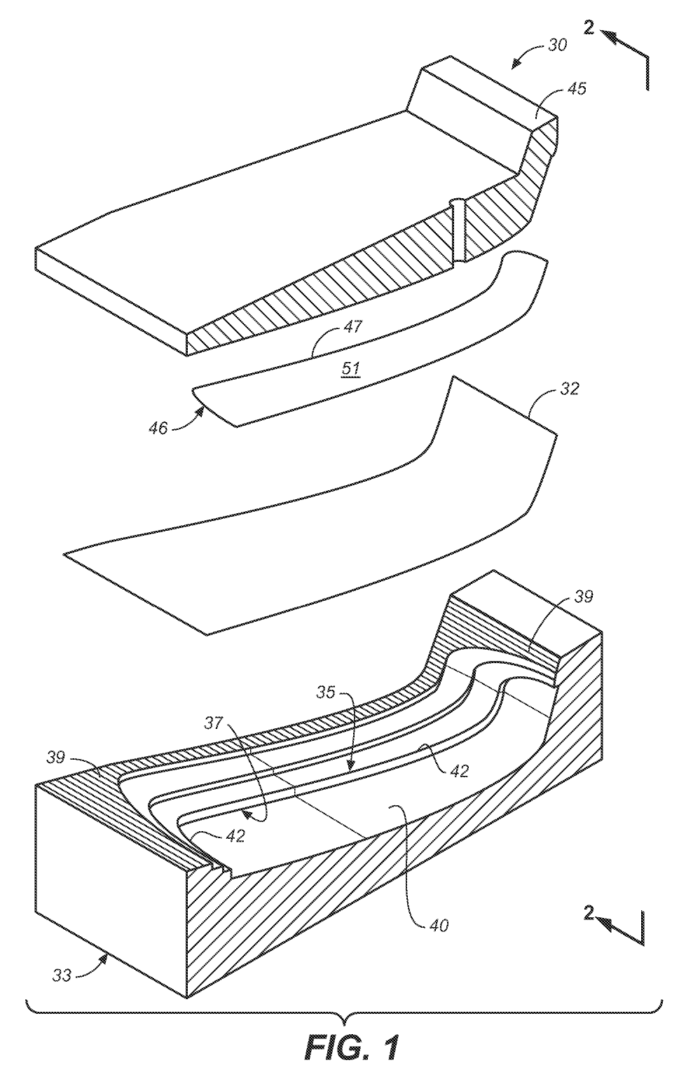

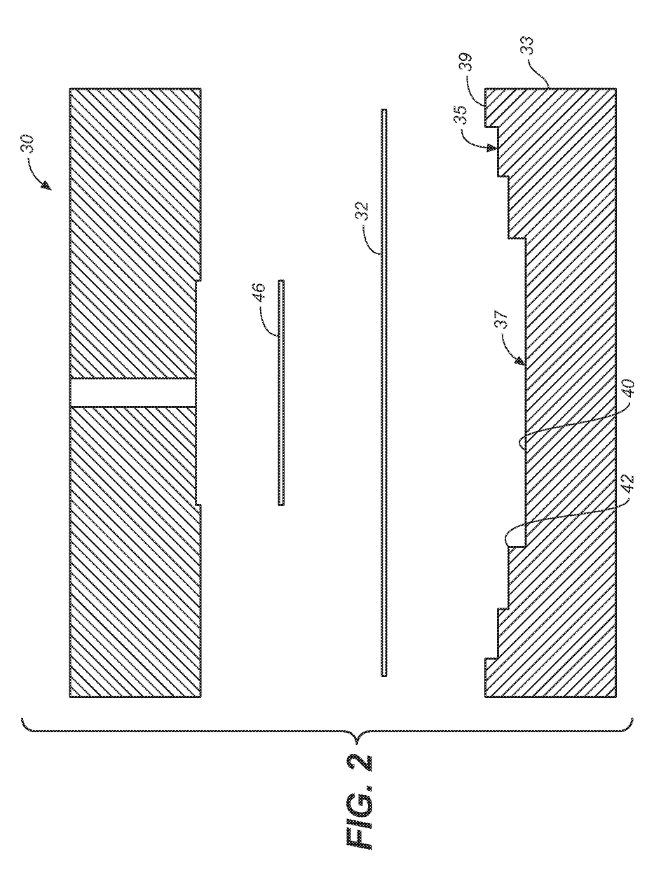

Turning now to the drawings, wherein like components are designated by like reference numerals throughout the various figures, attention is directed to FIGS. 1 and 2 which illustrate an apparatus, generally designated 30, for forming a three-dimensional (3D) object having large-radii curved surfaces and small-radii creases from a substantially flat blank sheet material 32, such as sheet metals including, but not limited to sheet steel and sheet aluminum. In the illustrated embodiment, the apparatus is used to form a 3D automobile hood from a substantially flat sheet material. One will appreciate, however, that a wide variety of 3D objects may be formed utilizing the apparatus of the present invention, including, but not limited to automotive parts such as fenders, trunk lids, dashboards and the like.

Apparatus 30 includes a shaping die 33 having a cavity 35 which has a shape generally corresponding to a desired outer surface of the 3D object. As best seen in FIGS. 1 and 2, a portion of the cavity, generally designated 37, is adapted to receive a portion of the sheet material that will ultimately form the 3D object, which object may be subsequently trimmed or otherwise finished to form a 3D product. An upper surface 39 of the shaping die receives an outer portion of the sheet of material. The cavity of the shaping die includes a large-radii curved surface 40 as well as one or more small-radii events 42, which are configured and designed to form the blank into a desired shape having corresponding large-radii curved surfaces and small-radii creases, respectively, as discussed in greater detail below.

Shaping or receiving portion 37 of shaping die 33 has a shape corresponding to a desired curved surface of a 3D object 44 which is shown in FIGS. 6 and 7. In the illustrated embodiment, the shaping portion has a stepped shape. The shaping die may be formed by removing cavity material from a block, mold casting, or other methods known in the art to provide a suitable female mold form. Suitable materials for the shaping die include, but are not limited to, hardened steel, cast iron, and other suitably rigid materials.

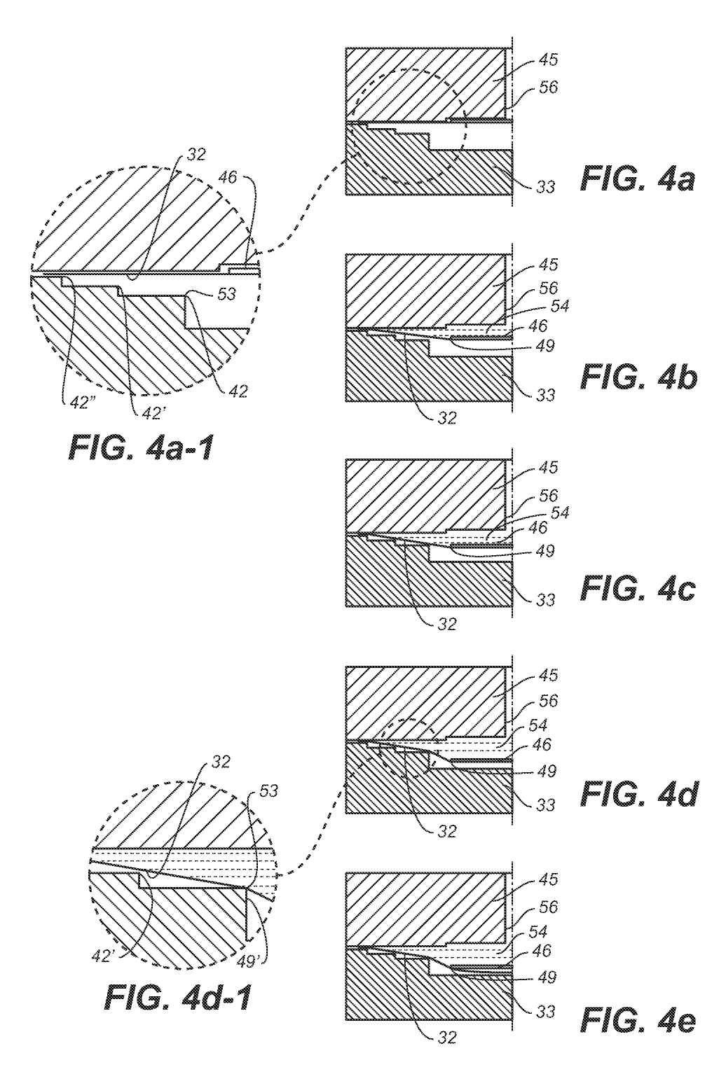

Apparatus 30 also includes a mating shoe 45 which is dimensioned and configured to cooperate with shaping die 33 to both clamp the blank sheet material 32 to the shaping die and form a fluid tight chamber with the blank sheet material, as can be seen in FIGS. 4(b)-4(e).

A forming member 46 is positioned within the fluid tight chamber and adjacent blank sheet material 32 opposite cavity 35. In the illustrated embodiment, the forming member is positioned directly above the sheet of material, and the sheet of material is positioned directly above the cavity. The forming member has a rigid edge 47 having a shape corresponding to a desired crease or inflection event 49 in the surface of the 3D object, which point can be seen in FIG. 4(e).

In the illustrated embodiment, the forming member is a flex-face platen. The forming member is substantially stronger and more rigid than the sheet material such that it will not crease during the forming process, but will gently flex to correspond to the sweeping curved surfaces of the cavity. As seen in FIG. 1, the platen and blank may be pre-flexed or pre-formed into an L-shape corresponding to the shape of shaping die 33. In other embodiments, forming member may be provided as a flat platen that will flex and curve to correspond to the shape of the shaping die, and then as fluid pressure is applied, further flex and curve to correspond to the shape of the cavity. In still other embodiments, the forming member is a rigid, unbending plate or platen.

Forming member 46 aids in the forming the inflection events or creases in blank 32. The forming member includes a body 51 having rigid edges 47. The forming member actively shapes the blank along the edges and/or body. As seen in FIGS. 4(b)-4(e), the edges of the forming member are rigid such that the edges create inflection points or lines 49 in the sheet of material during forming. The forming member body may be configured to flex or bow or it may be rigid. In one embodiment, the forming member body is configured to provide rigid resistance to the blank up to a desired force or pressure level and then flex to a desired degree thereafter. In another embodiment, the forming member includes rigid and flexible regions. Suitable materials for the forming member include, but are not limited to, rigid steel, alloys or other suitable materials that are substantially stiffer than the sheet material.

In the illustrated embodiment, forming member 46 and blank 32 are flexed into shapes complementing shaping die 33. In particular, as force in the form of fluid pressure is applied against the sheet material, and against the forming member, the blank is forced against cavity 35 of the shaping die 33 such that the blank forced against the shaping portion 37 and assumes the curved shape of the shaping portion.

With reference to FIGS. 4(b)-4(e), the sheet material blank is not shaped into the exact shape of the shaping portion of the shaping die. In this regard, the shaping die has a small-radii event 42 in the form of a creasing shoulder 53 which is dimensioned and configured to impart another small-radii event 49′ on sheet material (as shown in FIG. 4(d) and FIGS. 6 and 7). In the alternative, the surfaces of shaping portion 37 and forming member 46 may be configured to correspond exactly to the external shape of the desired 3D object. The use of creasing shoulders, however, may be more economical. As understood by one skilled in the art, complex shapes and increased material removal increases die cost; thus, the stepped configuration in the illustrated embodiment provides clearance for the sheet of material while minimizing the amount of material removed from the shaping die. For example, the costs and time involved in forming right-angled shoulders having a desired 3D crease shape may require less three-dimensional precision as would be required to fabricate a cavity having a shape exactly corresponding to the desired shape of the 3D product.

In either event, rigid edge 47 of the forming member can force the sheet material against the bottom curved surface 40 of the and localize sufficient force along rigid edge 47 to form a desired small-radii event 49 corresponding to a desired shape of object 44.

The cavity may also include other small-radii events 42′ which have shapes similar to small-radii events but do not make contact with blank sheet material 32 during use. For example, and as can be seen in FIG. 4(d), during application of force, the blank makes contact only with creasing shoulder 53 but not small-radii event 42′. Instead, small-radii event 42′ merely allows for more economical fabrication of the shaping die as it allows less material to be removed during fabrication of the shaping die. As can be seen in FIG. 4(b), small-radii event is positioned such that it will not contact sheet material 32 during operation, thus, providing an uncreased surface between inflection point 49′ and the edge of the finished product, as seen in FIGS. 6 and 7. While small-radii event 42″ does contact the sheet material, and form a crease 49″, as seen in FIG. 6, the crease 49″ is trimmed away and not left in the finished product 44′ shown in FIG. 7.

One will further appreciate that the shaping die may include various configurations and designs to produce the desired events in the blank. One skilled in the art will appreciate that shaping die 33 may include one or more small-radii events with various patterns and shapes depending upon the application and desired surface shape to be created.

In operation, and with reference to FIGS. 4(a)-4(e), forming member 46 works in conjunction with the small-radii events. As forced is applied to an upper side of the forming member and any exposed portion of sheet material 32 such that the forming member and blank sheet material 32 are depressed into the cavity. The material contacts the cavity at small-radii event 42. At the same time, the forming member depresses the material further to create inflection or stretching at small-radii event 49 along rigid edge 47 of the forming member.

As noted above, shoe 45 closes off the cavity of the shaping die and forms a working chamber 54 (best seen in FIGS. 4(b)-4(e)) immediately below a fluid inlet port 56 configured for injecting fluid against the forming member and blank. As seen in FIGS. 4(a)-4(d), the forming member 46 is releasably sealed directly to sheet material 32. Preferably, the seal is broken as shown in FIG. 4(e) which allows fluid pressure to enter between forming member 46 and sheet material 32 such that fluid pressure may bow the sheet material outwardly thereby assuming the final shape of 3D object 44. The manner in which the seal is formed and released will be described in greater detail below.

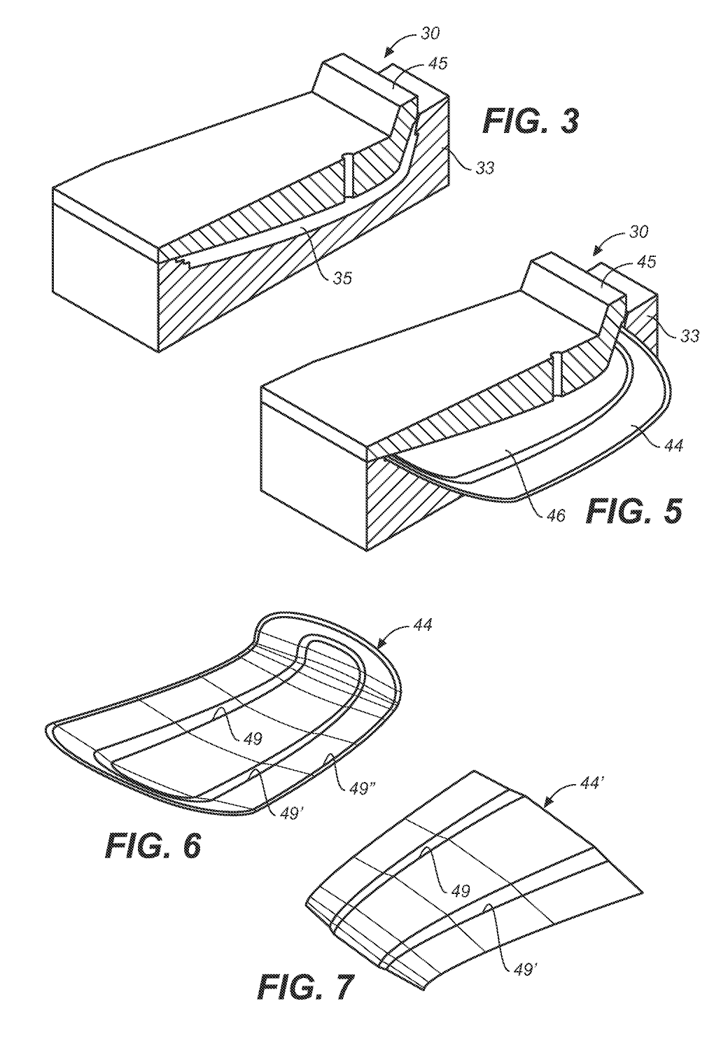

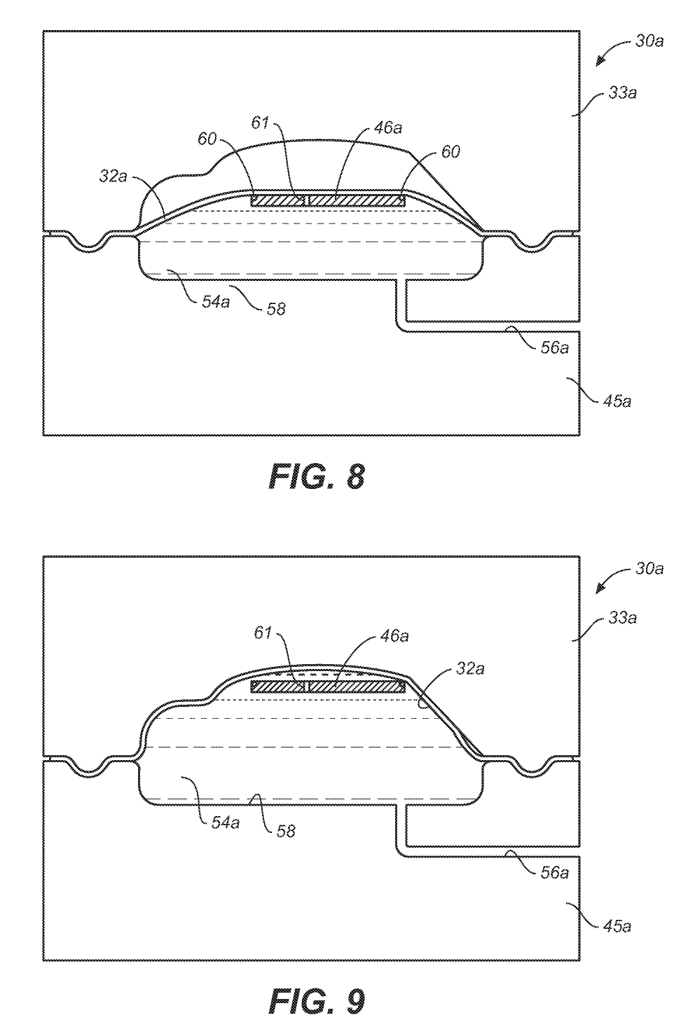

Turning now to FIGS. 8 and 9, another apparatus 30a is shown as a hydroforming apparatus that is substantially similar to that depicted in FIGS. 1-5 but includes a differently shaped cavity 35a and a more pronounced working chamber 54a. In the illustrated embodiment, shoe 45a defines a working chamber 54a having a bottom wall 58 spaced a greater distance from the sheet material thus forming a fluid reservoir opposite the shaping die for providing opposing fluid pressure applied to the blank.

In this embodiment, the forming member includes a fastener 60 for fastening the forming member to the sheet material. In practice, forming member 46 may be positioned relative to sheet material 32 and then the two secured together. In the case of hydroforming, the fastener seals the forming member to the sheet. In the illustrated embodiment, the fastener is a simple gasket seal which holds the forming member against the sheet material and prevents fluid from entering between the forming member and sheet of material during initial processing. Sealing may be accomplished by other known methods, such as, but not limited to, bellows and membranes with known fasteners.

With continued reference to FIGS. 8 and 9, fluid pressure drives forming member 46 and sheet material 32 into cavity 35 similar to the process depicted in FIG. 4. As fluid pressure increases, pressure relief valve 61 allows fluid pressure between the forming member and the sheet material. In this manner, the seal is configured to be released after an initial application of fluid pressure such that the sheet is allowed to be worked further independent of the forming member. In the illustrated embodiment, the forming member is fastened to the blank with a gasket seal, as noted above. However, one will appreciate that other configurations may be utilized including, but not limited to, wires limit the travel of the forming member, electronically-controlled releases, and the like. The forming member and fastener may also be designed such that the forming member breaks or releases from the sheet of material after the material has flexed a specified amount.

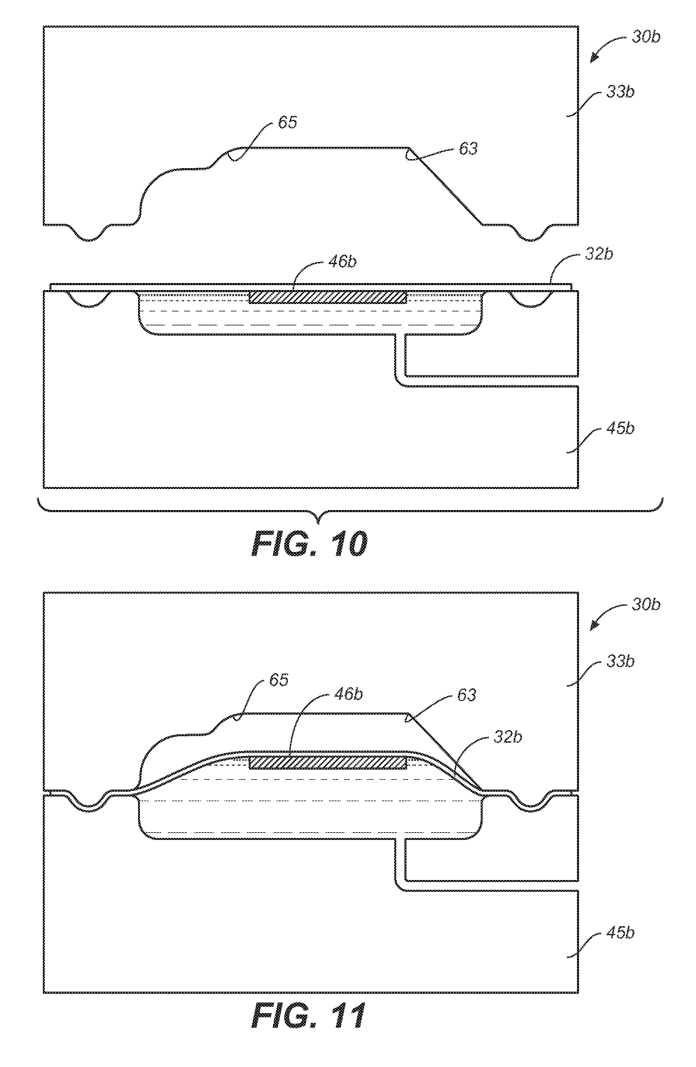

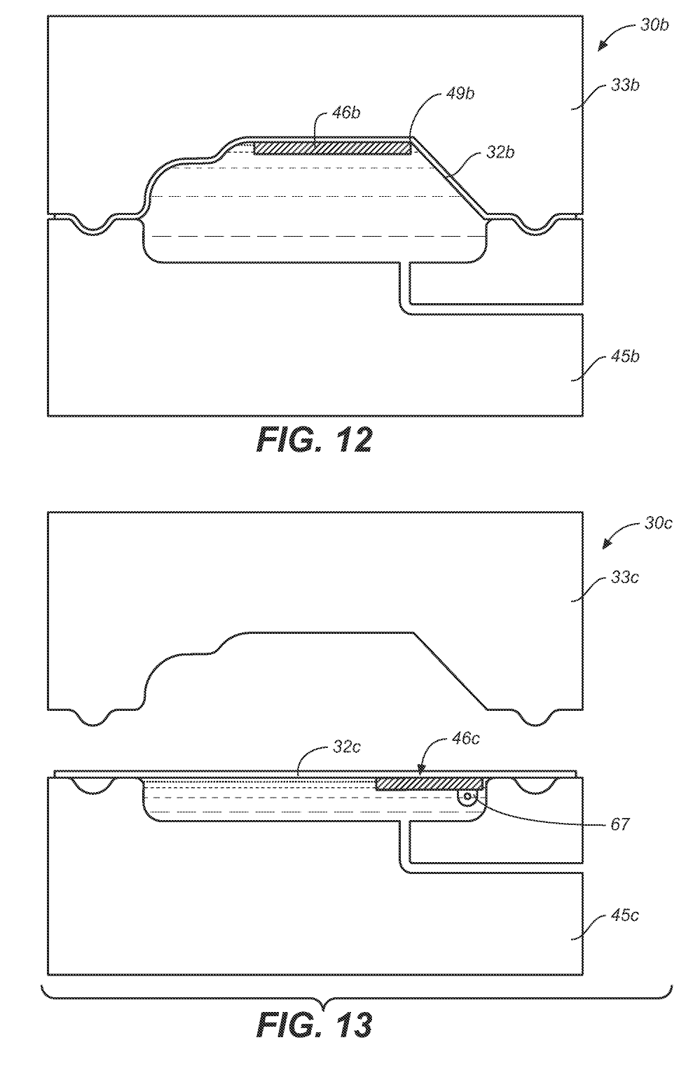

Turning to FIGS. 10-12, apparatus 30b is similar to that shown in FIGS. 8 and 9 but is configured not to release. Instead, one rigid edge 47b of forming member 46b is configured to force a portion of sheet material 32b into the angular corner 63 of shaping die 33b. As such, forming member 46b imparts a small-radii crease 49b on the sheet material that closely approximates the geometry of angular corner 63. In contrast, the forming member does not have an edge adjacent rounded corner 65, and instead, the sheet material relies on the fluid pressure within working chamber 54 to closely approximate the shape of the rounded corner. As with conventional hydroforming, the sheet material closely approximates the shape of the rounded corner and may or may not take the actual shape of the rounded corner.

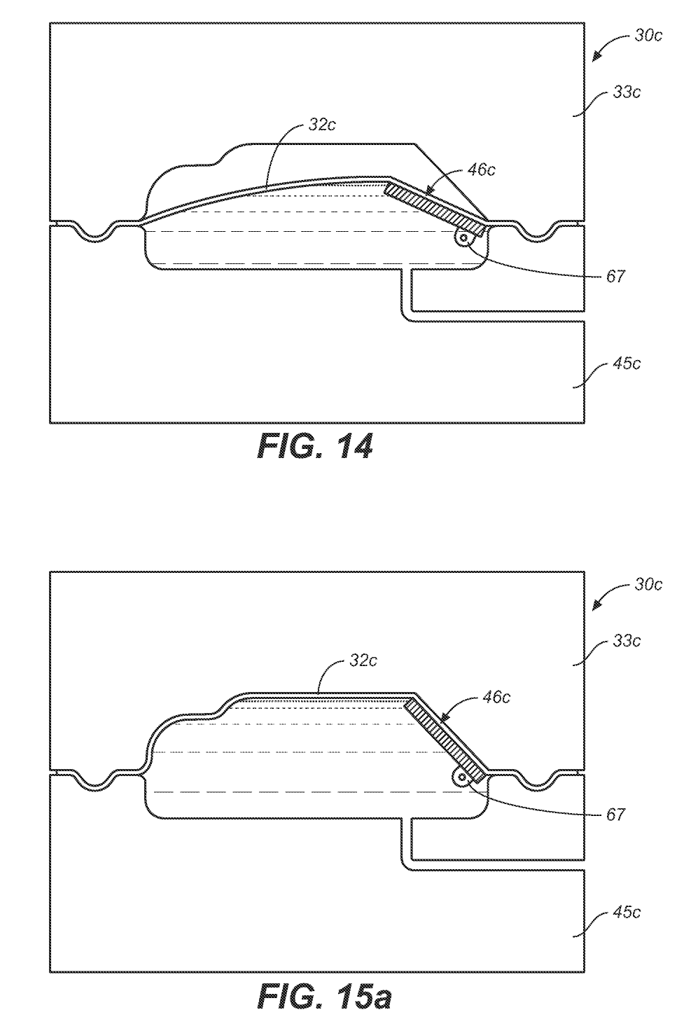

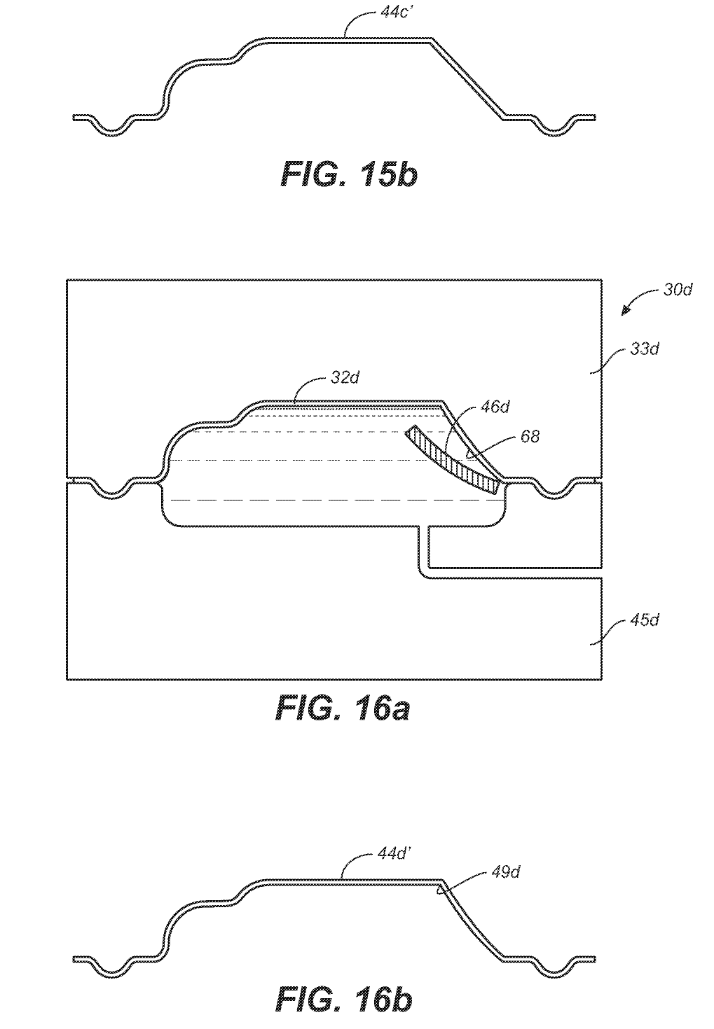

Turning to FIGS. 13-15, apparatus 30c is similar to those described above but include a forming member 46c having an outer end 67 pivotally secured to shoe 45c. The forming member may be secured by a hinge, flexible tab, or other known methods. In this manner, the forming member pivots such that rigid edge 47c pivots and forces sheet material 32c into angular corner 63c to form small-radii crease 49c, as shown in FIG. 15(a) to form a 3D object 44c having a small-radii crease 49c, best seen in FIG. 15(b).

In still a further embodiment shown in FIGS. 16(a) and 16(b), apparatus 30d is similar to that shown in FIGS. 13-15(a), but includes a curved forming member 46d which corresponds in shape to a inwardly convex surface 68. As such, angular corner 63d has an even smaller-radii event, namely a tighter crease. As such, apparatus 30d is capable of forming a 3D product that has an inwardly convex surface bordered by an angular crease 49d.

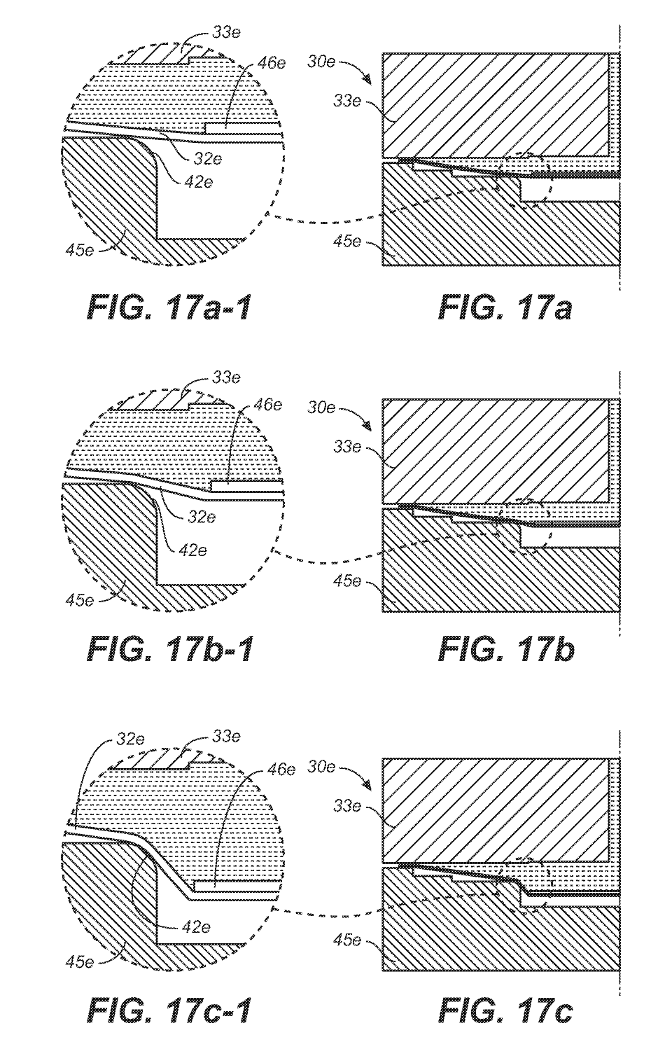

Turning now to FIGS. 17(a)-17(c), apparatus 30e is similar to those described above, but includes a small-radii event 42e in the form of a tight-radius, convex curve. As shown in FIG. 17, such an event can create a bellowed or serif shape rather than a tight corner. The application of force causes the material to stretch around the small-radii event and creates a smooth inflection point, as best seen in FIG. 17(c).

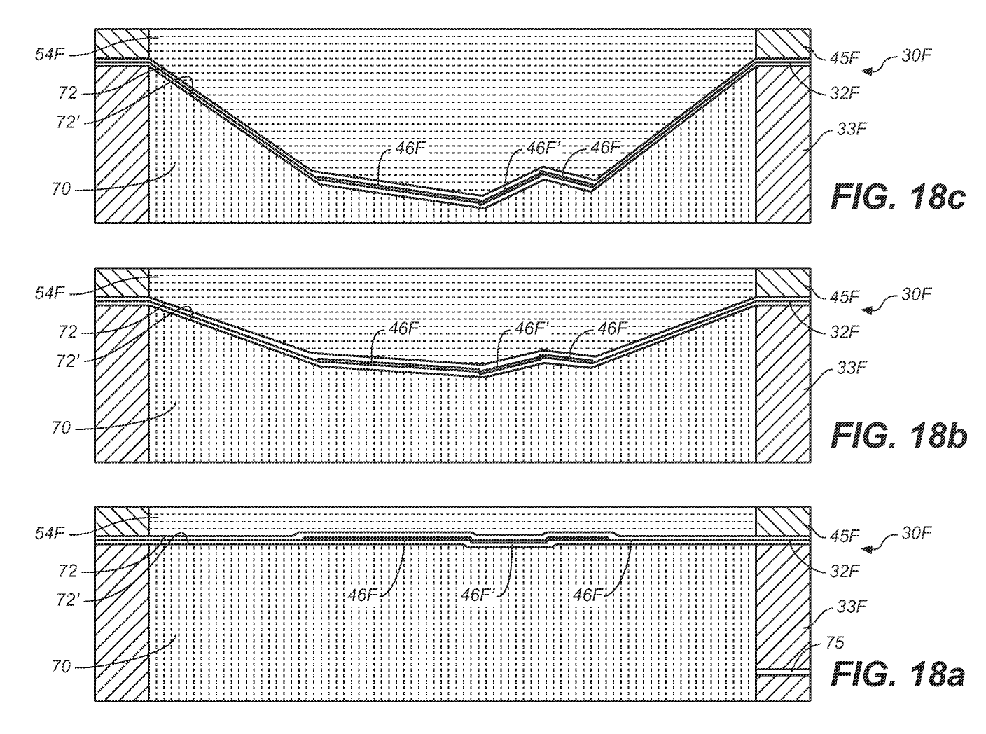

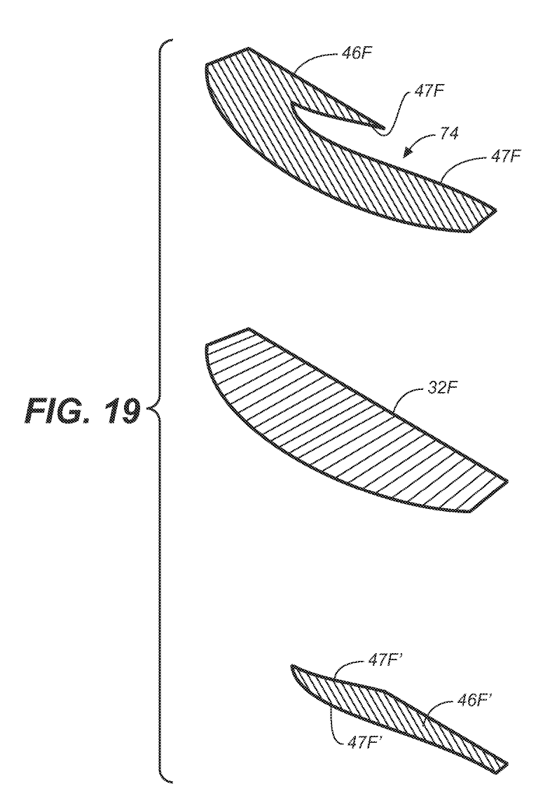

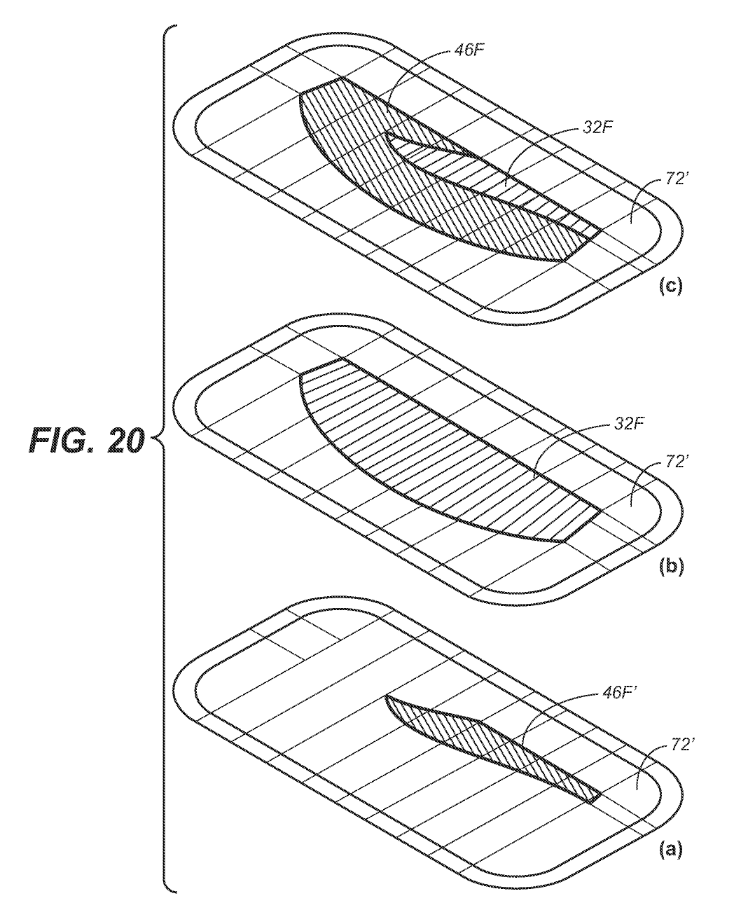

In still a further embodiment of the present invention shown in FIGS. 18(a)-18(c), apparatus 30f applies fluid pressure against a forming member and a sheet material, but includes a shaping die 33d having reactive fluid chamber 70 and a pair of membranes 72 and 72′ between which sheet material 32f and a pair of forming members 46f and 46f′ are placed. In this embodiment, one forming member 46f is releasably adhered or otherwise releasably secured to an upper surface of sheet material 32f, while a second forming member 46f′ is similarly fixed to a lower surface of the sheet material. As fluid pressure is applied on both sides of the sheet material and forming members, one may find that the forming members may simply be placed against the sheet material and held in place by the fluid pressure during operation.

In this embodiment, the upper forming member 46f includes a notch 74 delineated by rigid edges 47f. Lower forming member 46f′ corresponds in shape to notch 74 and is similarly delineated by rigid edges 47f′. In operation, the lower forming member 46f′ may be placed in proper orientation on the lower membrane 72′, sheet material 32f placed in proper orientation on the membrane above the lower forming member, and upper forming member 46f placed in proper orientation on the membrane above the lower forming member and the sheet material. Alternatively, the forming members may be adhered to the sheet material in proper orientations, and the sheet material in turn placed on the membrane.

As fluid pressure within working chamber 54f is applied against upper membrane 72 and thus against forming member 46f and the exposed portions of sheet material 32f, fluid within the reactive pressure chamber 70 provides resistance to the working fluid pressure. As working fluid pressure increases, an outlet in the form of a throttling pressure relief valve 75 in reactive pressure chamber 70 allows fluid to exit the chamber and allow the force of the working fluid pressure to (i) flex the forming members and the sheet material, and (ii) to bend sheet material 32f along the rigid edges 47f and 47′ of the forming members. As is the case of the above embodiments, the forming members are far more rigid than the sheet material, however, they are semi-rigid in that they will flex but not crease under the operating fluid pressures of apparatus 30f. As such, the forming members will localize bending forces against sheet material 32f along rigid edges 47f and 47f″ and thus cause small-radii events 49f along predetermined paths corresponding to the rigid edges.

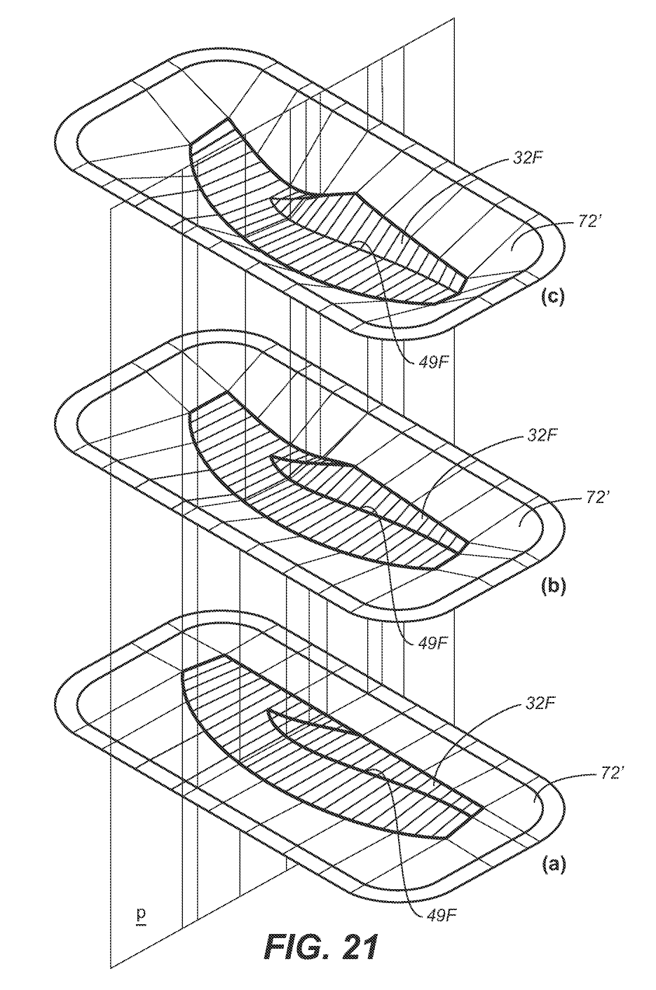

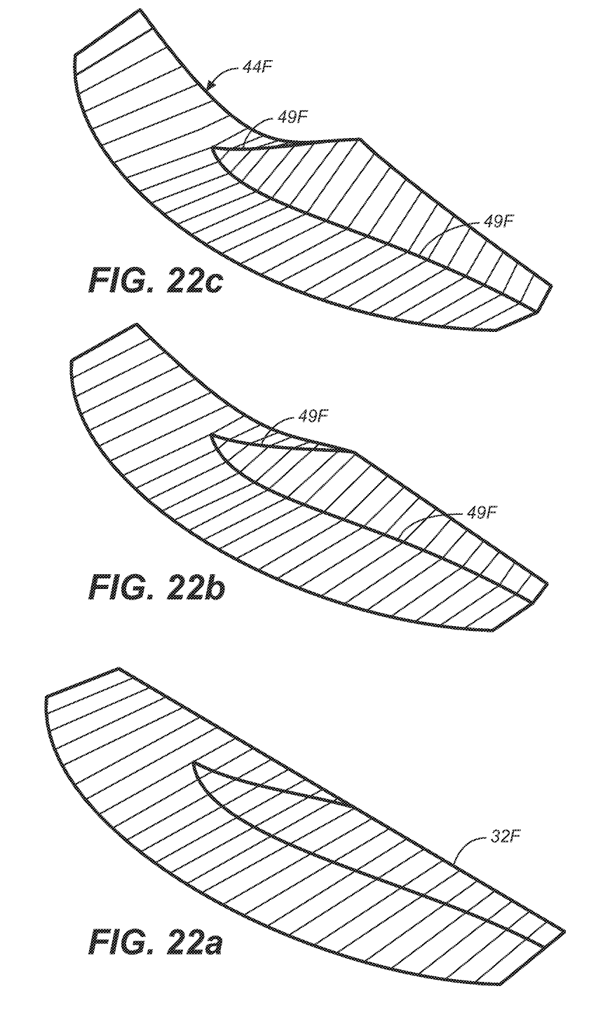

FIG. 21 schematically illustrates the flexing and bending of sheet material 32f (and movement of membrane 72′) during the forming process. In particular, stages (a), (b) and (c) correspond to the initial, intermediate and final stages of operation of apparatus 30f shown in FIGS. 18(a), 18(b) and 18(c), respectively. As can be seen in FIG. 21, substantial portions of sheet material are allowed to flex while bending is limited to small-radii events or creases 49f. In the illustrated embodiment, the sheet material has been formed into the shape of an automobile dashboard, as shown in FIG. 22. One will appreciate, however, that the illustrated apparatus and bending techniques are suitable for forming various 3D objects.

In the illustrated embodiment, upper and lower forming members 46f and 46f′ are effectively hinged with respect to one another by sheet material. In particular, as the forming members are secured to the sheet material, and the sheet material is capable of bending along rigid edges 47f and 47f, the forming members are effectively hinged together along their rigid edges. One will appreciate that the forming members may be secured to the sheet material on the same side of the sheet material. In such cases, the forming members may be directly hinged to one another.

While the above embodiments have been described as utilizing fluid pressure to apply force against the forming member and the sheet material, one will appreciate that the fluid liquid or gas. Generally liquid pressure will be applied in a controlled manner in that fluid pressure may be closely applied, monitored and controlled in a well known manner utilizing water and/or other non-compressible fluids. One will also appreciate that rapid gas techniques involving explosive application of gas pressure for applying force.

While the above embodiments have been described as utilizing fluid pressure to apply force against the forming member and the sheet material, one will appreciate that the fluid liquid or gas. Generally liquid pressure will be applied in a controlled manner in that fluid pressure may be closely applied, monitored and controlled in a well known manner utilizing water and/or other non-compressible fluids. One will also appreciate that rapid gas techniques involving explosive application of gas pressure for applying force.

For convenience in explanation and accurate definition in the appended claims, the terms “up” or “upper”, “down” or “lower”, “inside” and “outside” are used to describe features of the present invention with reference to the positions of such features as displayed in the figures.

In many respects the modifications of the various figures resemble those of preceding modifications and the same reference numerals followed by subscripts a “b”, “c”, “d”, “e” and “f” designate corresponding parts.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. An apparatus for forming a three-dimensional (3D) object from a sheet material, the apparatus comprising:
a sheet material;
a shaping die defining a cavity adapted to receive at least a portion of the sheet material, a portion of the cavity having a shape corresponding to a desired surface of the 3D object; and
a forming member positioned relative to the sheet material opposite the cavity and having a rigid edge having a shape corresponding to a desired small-radii event of the 3D object;
wherein when force is applied to the sheet material and to the forming member, the sheet material is forced against the portion of the cavity to form the desired surface, and the rigid edge is forced against the sheet material to form the desired small-radii event.

2. An apparatus according to claim 1, wherein the cavity further includes a concave corner.

3. An apparatus according to claim 1, wherein the forming member is a rigid wire.

4. An apparatus according to claim 1, wherein the forming member is a platen having a substantially flat body and rigid edges.

5. An apparatus according to claim 4, wherein the forming member has a shape corresponding to the desired object shape.

6. An apparatus according to claim 4, wherein the forming member includes a line of weakness configured to correspond to a bend line in the desired object.

7. An apparatus according to claim 4, wherein the apparatus is a hydroforming apparatus applying fluid liquid pressure to the sheet of material.

8. An apparatus according to claim 7, further comprising a fastener for fastening the forming member to the sheet.

9. An apparatus according to claim 8, wherein the fastener seals the forming member to the sheet.

10. An apparatus according to claim 9, wherein the seal is configured to be released after an initial application of fluid pressure such that the sheet is allowed to be worked further independent of the forming member.

11. An apparatus according to claim 4, further comprising a second forming member, wherein a second forming edge and forming edge correspond.

12. An apparatus according to claim 11, wherein the first and second forming members are fastened by a hinge.

13. An apparatus according to claim 12, wherein the second forming member is a rigid platen.

14. An apparatus according to claim 13, wherein at least one of the first forming member and second forming member is fastened to the blank and each of the first and second forming members have shapes corresponding to two adjacent surfaces of the object to be formed.

15. An apparatus according to claim 13, further comprising shoe defining a liquid reservoir opposite the shaping die for opposing fluid pressure applied to the blank, wherein an outer edge of the first forming member is secured to an outer side of the shoe.

16. An apparatus according to claim 15, wherein the first and second forming members have shapes corresponding to adjacent surfaces of the object to be formed.

17. A method of forming a three-dimensional object from a blank of sheet material comprising:
providing a shaping die defining a cavity and having a shape corresponding to a desired surface of the three-dimensional object including a small-radii event;
providing a blank of sheet material opposite the shaping die;
providing a forming member positioned relative to the blank and opposite the cavity, the forming member including a rigid edge corresponding to the small-radii event;
clamping the blank between the shaping die and a shoe configured to provide force to the blank;
shaping the blank by applying force to the blank and the forming member whereby the blank is forced against a portion of the cavity and the rigid edge is forced against the blank to form the desired small-radii event;
removing the formed blank; and
finishing the formed blank into the desired three-dimensional object.

18. A method according to claim 17, wherein forming step is accomplished by high-pressure gas.

19. A method according to claim 17, wherein forming step is accomplished by applying liquid pressure to the sheet of material.

20. A method according to claim 19, further comprising the step of fastening the forming member to the blank before clamping the blank.

21. A method according to claim 20, wherein the fastening step seals the forming member to the sheet.

22. A method according to claim 19, further comprising a second forming step wherein the seal is configured to be released after the first forming step to allow further working of the blank.

23. An apparatus for forming a three-dimensional object from a sheet of material, the apparatus comprising:
a sheet of material;
a shaping die defining a cavity adapted to receive a portion of the sheet and having a shape corresponding to a desired surface of the three-dimensional object;
a shoe mounted opposite the shaping die and including a fluid inlet passage for applying pressurized fluid above the sheet, wherein the shoe and the shaping die are configured to clamp the lateral edges of the blank therebetween; and
a platen positioned adjacent to the sheet opposite the cavity and having a body and rigid edge corresponding to a desired small-radii event of the three-dimensional object,
wherein fluid pressure is applied to sheet material and platen such that the sheet is forced against a portion of the cavity and platen.

24. The apparatus according to claim 23, wherein the platen is rotationally fixed at one end to the shoe.

25. The apparatus according to claim 23, wherein the apparatus is a hydroforming apparatus applying fluid liquid pressure to the sheet of material.

26. An apparatus according to claim 25, further comprising a fastener for fastening the forming member to the sheet of material.

27. An apparatus according to claim 26, wherein the fastener seals the platen to the sheet.

28. An apparatus according to claim 27, wherein the seal is configured to be released after an initial application of fluid pressure such that the sheet is allowed to be worked further independent of the forming member.

29. The apparatus according to claim 23, further comprising a second platen in hinged engagement with the first platen along a common edge.

30. The apparatus according to claim to claim 29, wherein the platen includes a first portion and a second portion partitioned by a line of weakness.

31. The apparatus according to claim to claim 23, wherein the platen body is substantially rigid.

32. The apparatus according to claim to claim 31, wherein the platen body is configured to flex and/or stretch under high pressure into a shape corresponding to a desired surface of the three-dimensional object.

33. The apparatus according to claim to claim 32, further including high-powered gas assist configured for applying instantaneous high pressure to the sheet and platen.
